(19) United States
(12) Patent Application Publication
(10) Pub. No.: US 2020/0116087 A1
(43) Pub. Date: Apr. 16, 2020

(54) VALVE MECHANISM AND ENGINE GAS-EXHAUSTION DEVICE PROVIDED WITH VALVE MECHANISM

(71) Applicant: MAZDA MOTOR CORPORATION, Hiroshima (JP)

(72) Inventors: Mitsuyuki MUROTANI, Hiroshima-shi, Hiroshima (JP); Shuhei TSUJITA, Hatsukaichi-shi, Hiroshima (JP); Einosuke SUEKUNI, Higashihiroshima-shi, Hiroshima (JP); Junji UMEMURA, Higashihiroshima-shi, Hiroshima (JP)

(73) Assignee: MAZDA MOTOR CORPORATION, Hiroshima (JP)

(21) Appl. No.: 16/068,628

(22) PCT Filed: Jan. 8, 2016
(86) PCT No.: PCT/JP2016/000083

§ 371 Date: Jul. 6, 2018

(51) Int. Cl. F02D 9/04; F02D 9/10; F16K 1/22

(52) U.S. Cl. CPC F02D 9/04; F02D 9/1065; F16K 1/223; F16K 1/221; F02D 9/101

(57) ABSTRACT

A valve mechanism includes a valve (a butterfly valve 30) arranged in a path in which gas flows, a drive shaft (32) coupled to the valve, and a lever member (33) attached to a lever attachment portion (321) provided at the drive shaft. The lever attachment portion of the drive shaft has a non-circular cross-sectional shape. The lever member has a through-hole (331) in a shape corresponding to a non-circular cross section of the lever attachment portion, and is fitted onto the lever attachment portion. The lever member is fixed to the drive shaft in such a manner that a first contact portion (a first contact member 34) and a second contact portion (323) sandwich the lever member in an axial direction of the drive shaft.

### TECHNICAL FIELD

The technique disclosed herein relates to a valve mechanism and an engine exhaust device including the valve mechanism.

### BACKGROUND ART

Patent Document 1 describes that in a turbosupercharger-equipped engine, an exhaust valve device is interposed between a separate exhaust path communicating with each cylinder and a turbine. The exhaust valve device is configured to change, according to the rotation speed of the engine, the flow area of exhaust gas discharged from the engine, thereby changing the flow velocity of the exhaust gas introduced into the turbine.

The exhaust device described in Patent Document 1 will be described in more detail. The engine is an in-line four-cylinder engine having four first to fourth cylinders. The separate exhaust paths include a first exhaust path communicating with the first cylinder, a second exhaust path at which paths communicating with the second and third cylinders join together, and a third exhaust path communicating with the fourth cylinder. The exhaust valve device includes an upstream exhaust path connected to the separate exhaust paths. A turbosupercharger includes a downstream exhaust path connecting the upstream exhaust path and a turbine housing.

The upstream exhaust path includes three separate paths each communicating with the first to third exhaust paths. Each of three paths is branched into two paths including a low-velocity path and a high-velocity path. The downstream exhaust path has separate low-velocity and high-velocity paths each communicating with the low-velocity and high-velocity paths of the upstream exhaust path. Each of the low-velocity and high-velocity paths of the downstream exhaust path joins three separate paths of the upstream exhaust path. A downstream end of the downstream exhaust path is connected to an inlet of the turbine after the low-velocity and high-velocity paths join together.

A butterfly valve is arranged in the high-velocity path of the upstream exhaust path. A drive shaft coupled to the butterfly valve is rotated by an actuator, and accordingly, the butterfly valve switches between an open state and a closed state.

When the engine speed is equal to or lower than a predetermined rotation speed, the butterfly valve is closed. In this manner, the flow area of the exhaust gas is narrowed, and the flow velocity of the exhaust gas is increased. Thus, turbine drive force is increased in a low rotation range of the engine. On the other hand, when the engine speed exceeds the predetermined rotation speed, the butterfly valve is opened. In this manner, in a high rotation range of the engine, the exhaust gas can be introduced into the turbine through both of the low-velocity path and the high-velocity path. Thus, exhaust resistance is reduced, and the turbine drive force is increased.

Patent Document 2 describes a butterfly valve arranged in an EGR path through which exhaust gas flows. The EGR path has first and second paths arranged in a right-to-left direction. The butterfly valve is arranged in each of the first and second paths, and two butterfly valves are fixed to a valve shaft arranged to cross the first and second paths. The valve shaft extends outward of the EGR path, and a lever member connected to a negative pressure type actuator is attached to a lever attachment portion provided at an end portion of the valve shaft.

In a configuration described in Patent Document 2, the lever attachment portion of the valve shaft is configured such that part of a peripheral surface of the valve shaft having a circular cross section is processed into flat surfaces. More specifically, the lever attachment portion has two flat surfaces parallel to each other on both sides of the center axis of the lever attachment portion. At the lever member fitted and fixed onto the lever attachment portion, a through-hole flattened at two portions of an inner peripheral surface thereof is formed corresponding to the cross-sectional shape of the lever attachment portion.

### CITATION LIST

### Patent Document

PATENT DOCUMENT 1: Japanese Patent Laid-Open Publication No. 2014-80900

PATENT DOCUMENT 2: Japanese Patent Laid-Open Publication No. 2011-256942

### SUMMARY OF THE INVENTION

### Technical Problem

As described in Patent Document 2, the lever attachment portion is configured such that part of the peripheral surface of the valve shaft is processed into the flat surfaces. With this configuration, position determination between the lever member and the lever attachment portion in a valve shaft rotation direction can be made upon assembly. However, due to such processing, it is difficult to ensure dimension accuracy for press-fitting the lever member onto the lever attachment portion, and a clearance is formed between the through-hole of the lever member and the lever attachment portion.

In the exhaust valve device described in Patent Document 1, when the butterfly valve arranged in the high-velocity path of the exhaust path closes the high-velocity path, the butterfly valve receives a high exhaust gas pressure.

Suppose that in the exhaust valve device described in Patent Document 1, the drive shaft for opening/closing the butterfly valve employs the attachment configuration of the lever member described in Patent Document 2. When the butterfly valve receives the high exhaust gas pressure, the lever member and the drive shaft rattle due to the clearance between the through-hole of the lever member and the lever attachment portion. For this reason, when the butterfly valve closes the high-velocity path, noise might be caused at an attachment portion of the lever member due to exhaust pulsation.

The technique disclosed herein has been made in view of the above-described points, and is intended to prevent occurrence of noise due to rattling between a drive shaft of a valve arranged in an exhaust path and a lever member attached to the drive shaft.

### Solution to the Problem

The technique disclosed herein relates to a valve mechanism including a valve arranged in a path in which gas flows and configured to open/close the path, a drive shaft coupled to the valve and configured to rotate the valve, and a lever member attached to a lever attachment portion provided at the drive shaft and configured to swing about the drive shaft to rotate the drive shaft.

In the valve mechanism, the lever attachment portion of the drive shaft has a non-circular cross-sectional shape. The lever member has a through-hole in a shape corresponding to a non-circular cross section of the lever attachment portion, is fitted onto the lever attachment portion, and is fixed to the drive shaft in such a manner that a first contact portion and a second contact portion provided on the drive shaft contact a side surface of the lever member to sandwich the lever member in an axial direction of the drive shaft.

According to such a configuration, the lever member is attached to the lever attachment portion of the drive shaft. The lever attachment portion has the non-circular cross-sectional shape, and the lever member has the through-hole in the shape corresponding to the cross section of the lever attachment portion. Thus, position determination between the lever member and the lever attachment portion in a drive shaft rotation direction can be made upon assembly. Meanwhile, a clearance can be formed between the through-hole of the lever member and the lever attachment portion.

In the above-described configuration, the first contact portion and the second contact portion sandwich, in the axial direction of the drive shaft, the lever member fitted onto the lever attachment portion. The lever member is fixed to the drive shaft by sandwiching between the first contact portion and the second contact portion. Thus, when the valve receives the pressure of gas flowing through the path, even if there is the clearance between the through-hole of the lever member and the lever attachment portion, rattling between the lever member and the drive shaft is prevented. Thus, occurrence of noise at an attachment portion of the lever member is prevented.

The lever attachment portion may have a flat surface at part of a peripheral surface thereof, and the through-hole of the lever member may have, at part of an inner peripheral surface thereof, a flat surface configured to contact the flat surface of the lever attachment portion.

Part of the peripheral surface of the lever attachment portion is the flat surface. Thus, position determination between the lever member and the lever attachment portion can be made upon assembly while a processing step for forming the flat surface is added. For this reason, it is difficult to ensure dimension accuracy for press-fitting the lever member onto the lever attachment portion.

In the above-described configuration, the lever member is fixed to the drive shaft by sandwiching between the first contact portion and the second contact portion. Thus, position determination between the lever member and the lever attachment portion can be made upon assembly while rattling between the lever member and the drive shaft is prevented.

The first contact portion may include a first contact member fitted onto the drive shaft and separated from the drive shaft, and the second contact portion may be provided integrally with the drive shaft at a portion adjacent to the lever attachment portion of the drive shaft in the axial direction.

With this configuration, when the lever member is attached to the lever attachment portion, the lever member is fitted onto the drive shaft, and contacts the second contact portion provided integrally with the drive shaft. Thereafter, the first contact member is fitted onto the drive shaft, and contacts the lever member. Then, the first contact member and the second contact member sandwich the lever member. In this state, the first contact member is fixed to the drive shaft, and in this manner, assembly of the drive shaft and the lever member is completed.

The first contact member may be press-fitted onto the drive shaft. With this configuration, the first contact member can be easily fixed to the drive shaft with the lever member being sandwiched. When the valve receives the gas pressure or the drive shaft rotates in association with swinging of the lever member, vibration might be caused. However, the first contact member is, by press-fitting, fixed to the drive shaft, and therefore, there is an advantage that the first contact member is less loosened. That is, a state in which the first contact member is stably fixed to the drive shaft can be maintained for a long period of time.

An engine exhaust device disclosed herein includes the above-described valve mechanism, and an exhaust path including a first path and a second path provided in parallel to each other.

The valve is arranged in the first path, and is configured to open/close the first path. The drive shaft extends outward of the exhaust path. The lever attachment portion is provided at an end portion of the drive shaft, the end portion being separated from the exhaust path by a predetermined distance.

According to such a configuration, the above-described valve mechanism is arranged in the exhaust path. Specifically, the valve mechanism is arranged in the first path of the first and second paths provided in parallel to each other, thereby opening/closing the first path. When the first path is closed, exhaust gas passes through only the second path. When the first path is opened, the exhaust gas passes through both of the first and second paths.

Since high-temperature exhaust gas passes through the exhaust path, the valve tends to be at high temperature. Moreover, the temperature of the drive shaft coupled to the valve also increases, and therefore, the drive shaft thermally expands.

In the above-described configuration, the lever attachment portion is provided at the end portion of the drive shaft separated from the exhaust path by the predetermined distance. Since the lever attachment portion is separated from the exhaust path, thermal expansion is reduced. Although the lever attachment portion is attached to the lever member, an adverse effect due to thermal expansion is avoided at the attachment portion of the lever member.

The first contact portion may include the first contact member fitted onto the drive shaft and separated from the drive shaft, and the first contact member may be made of a material having a smaller linear coefficient of expansion than that of the drive shaft.

With this configuration, the amount of deformation due to heat of the first contact member is, at the attachment portion of the lever member, greater than the amount of deformation due to heat of the drive shaft. As a result, even when the drive shaft thermally expands, the first contact member can be maintained with the first contact member being fitted onto the drive shaft.

### Advantages of the Invention

As described above, according to the valve mechanism and the engine exhaust device, the lever member fitted onto the lever attachment portion of the drive shaft is fixed to the drive shaft by sandwiching between the first contact portion and the second contact portion. Thus, rattling between the lever member and the drive shaft can be prevented, and occurrence of noise at the attachment portion of the lever member can be prevented.

### BRIEF DESCRIPTION OF THE DRAWINGS

FIG. 1 is a schematic partial sectional view of a configuration of a turbosupercharger-equipped engine exhaust device.

FIG. 2 is a sectional view of the configuration of the turbosupercharger-equipped engine exhaust device.

FIG. 3 is a perspective view of a configuration of an exhaust valve device from a turbine side.

FIG. 4 is a side view of the configuration of the exhaust valve device.

FIG. 5 is a V-V sectional view of FIG. 3.

FIG. 6 is a schematic view for describing a VI-VI section of FIG. 3.

FIG. 7 is an enlarged perspective view of an attachment portion of a lever member.

FIG. 8 is a sectional view of a configuration of the attachment portion of the lever member.

FIG. 9 is a perspective view of a lever attachment portion and the lever member.

FIG. 10 is a sectional view of a negative pressure type actuator.

FIG. 11 is a view for describing displacement when an output shaft of the negative pressure type actuator advances/retreats.

FIG. 12 is a perspective view of a stopper and a stopper engagement portion of the negative pressure type actuator.

### DESCRIPTION OF EMBODIMENTS

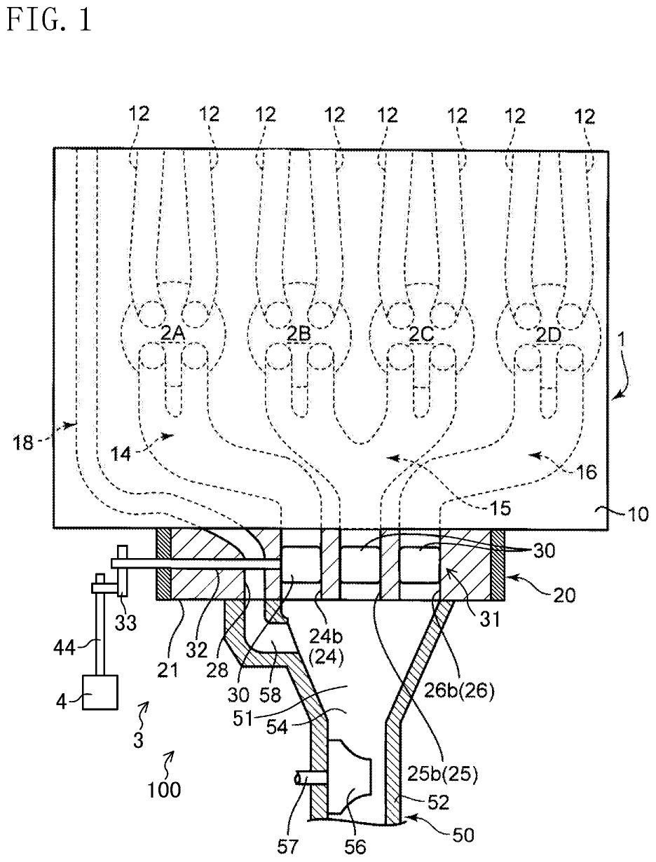

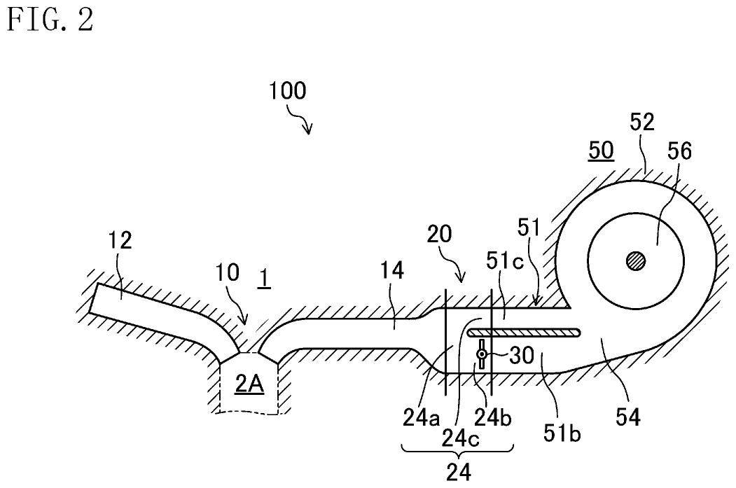

Hereinafter, an engine exhaust device disclosed herein will be described in detail with reference to the drawings. Note that description below will be set forth as an example. FIGS. 1 and 2 illustrate an engine exhaust device 100. An engine illustrated in these figures is an in-line four-cylinder four-cycle engine, and in the present embodiment, is configured such that combustion is performed in the order of a first cylinder, a third cylinder, a fourth cylinder, and a second cylinder. This engine includes an in-line four-cylinder engine body 1 having four cylinders 2A to 2D (a first cylinder 2A, a second cylinder 2B, a third cylinder 2C, and a fourth cylinder 2D) arranged in line. The engine exhaust device 100 includes an exhaust manifold for exhausting exhaust gas generated in the engine body 1, an exhaust valve device 20 described later in detail, and a turbosupercharger 50.

This engine does not include a separate component as the exhaust manifold. Although will be described later in detail, separate exhaust paths 14, 15, 16 of the engine body 1 (a cylinder head 10), upstream exhaust paths 24, 25, 26 of the exhaust valve device 20, and an exhaust introduction path portion 51 and a junction portion 54 of the turbosupercharger 50 cooperate with each other to form the exhaust manifold.

The engine is configured such that the turbosupercharger 50 is actuated by the exhaust gas exhausted through the exhaust manifold to compress intake air introduced into each cylinder 2A to 2D and increase a intake air pressure. Moreover, it is configured such that the flow velocity of the exhaust gas introduced into the turbosupercharger 50 is, according to a vehicle operation state, controlled by the exhaust valve device 20 interposed between the engine body 1 and the turbosupercharger 50. With this configuration, the effect of increasing an engine torque by the turbosupercharger 50 is obtained across a wide range from a low rotation range to a high rotation range of an engine rotation speed range.

Note that in description below, for the sake of clarity of a direction relationship, the direction of arranging the cylinders 2A to 2D in the engine body 1 will be referred to as a “right-to-left direction,” a direction (an upper-to-lower direction in FIG. 1) perpendicular to this direction will be referred to as a “front-to-back direction,” and a side close to the turbosupercharger 50 will be referred to as a “front side” of the engine, with reference to FIG. 1.

In the cylinder head 10 of the engine body 1, three separate exhaust paths are formed for four cylinders 2A to 2D. Specifically, the first separate exhaust path 14 used for gas exhausting of the first cylinder 2A, the second separate exhaust path 15 used in common for gas exhausting of the second cylinder 2B and the third cylinder 2C not continuous in a gas exhausting sequence, and the third separate exhaust path 16 used for gas exhausting of the fourth cylinder 2D are formed. The second separate exhaust path 15 is in a shape branched in a Y-shape on an upstream side so that the second separate exhaust path 15 can be used in common for the second cylinder 2B and the third cylinder 2C.

These separate exhaust paths 14, 15, 16 are formed such that downstream end portions thereof are gathered to the substantially center of the cylinder head 10 in the right-to-left direction, and open at a front surface of the cylinder head 10 in a state in which the separate exhaust paths 14, 15, 16 are arranged close to each other in line in the right-to-left direction.

Moreover, an EGR downstream path 18 is formed in the cylinder head 10. As illustrated in FIG. 1, the EGR downstream path 18 is formed to cross, in the front-to-back direction, the left side of the first cylinder 2A in the cylinder head 10. An upstream end portion of the EGR downstream path 18 opens at a position at the left of the first separate exhaust path 14 at the front surface of the cylinder head 10. On the other hand, a downstream end portion of the EGR downstream path 18 opens at a back surface of the cylinder head 10. Note that a reference numeral “12” in FIG. 1 indicates an intake port of each cylinder 2A to 2D formed in the cylinder head 10. The downstream end portion of the EGR downstream path 18 opens at a position at the left of the intake port 12 of the first cylinder 2A among the intake ports 12.

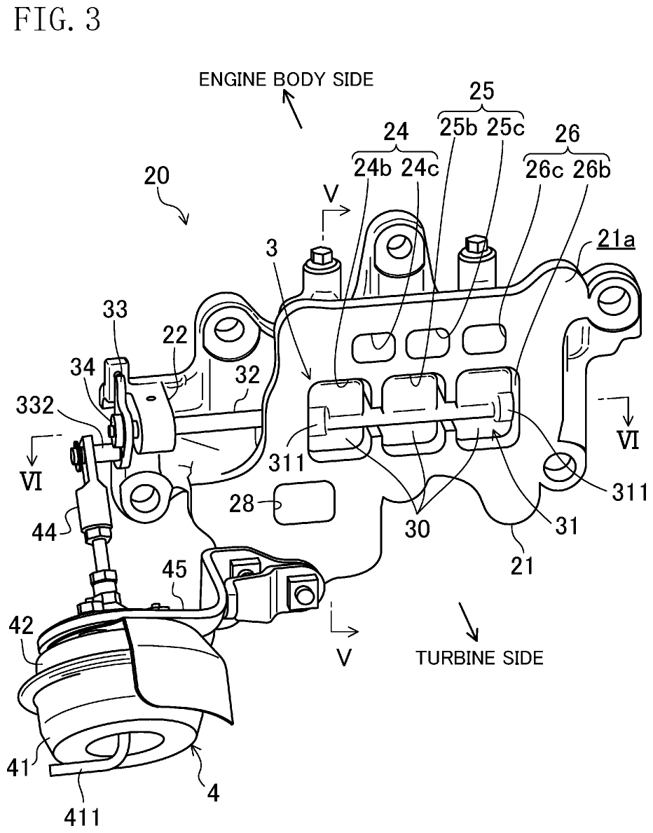

FIG. 3 illustrates the exhaust valve device 20 viewed from a turbine side. The exhaust valve device 20 is configured to change the flow area of the exhaust gas exhausted from the engine body 1, thereby changing the flow velocity of the exhaust gas introduced into the turbosupercharger 50. The exhaust valve device 20 is, with bolts, fixed to a front surface of the engine body 1.

The exhaust valve device 20 includes a device body 21 having three separate upstream exhaust paths 24, 25, 26 (the first upstream exhaust path 24, the second upstream exhaust path 25, and the third upstream exhaust path 26) each communicating with the separate exhaust paths 14, 15, 16 of the cylinder head 10 and an EGR intermediate path 28 communicating with the EGR downstream path 18 of the cylinder head 10; and an exhaust variable valve 3 configured to change the flow area of the exhaust gas in the upstream exhaust paths 24, 25, 26. Note that the device body 21 is formed of a metal casted body.

Each upstream exhaust path 24, 25, 26 is in a shape branched in a Y-shape on a downstream side. That is, as illustrated in FIGS. 2 and 3, the first upstream exhaust path 24 has a common path 24a communicating with the first separate exhaust path 14 of the cylinder head 10, and a high-velocity path 24b and a low-velocity path 24c branched into two upper and lower paths from the common path 24a. Similarly, each of the second upstream exhaust path 25 and the third upstream exhaust path 26 has a common path 25a, 26a (not shown) communicating with the separate exhaust path 15, 16 of the cylinder head 10, and a high-velocity path 25b, 26b and a low-velocity path 25c branched into two upper and lower paths from the common path 25a, 26a. Note that in this embodiment, the high-velocity path 24b, 25b, 26b in each upstream exhaust path 24, 25, 26 corresponds to a first path, and the low-velocity path 24c, 25c, 26c in each upstream exhaust path 24, 25, 26 corresponds to a second path. The low-velocity path 24c, 25c, 26c is formed to have a smaller flow path sectional area than that of the high-velocity path 24b, 25b, 26b.

Each high-velocity path 24b, 25b, 26b has a substantially rectangular sectional shape, and as illustrated in FIG. 3, the high-velocity paths 24b, 25b, 26b are formed in line in the right-to-left direction. Similarly, each low-velocity path 24c, 25c, 26c has a substantially rectangular sectional shape, and at positions above the high-velocity paths 24b, 25b, 26b, the low-velocity paths 24c, 25c, 26c are formed in line in the right-to-left direction.

Meanwhile, the EGR intermediate path 28 is formed at a left end of the device body 21 as illustrated in FIGS. 1 and 3. The EGR intermediate path 28 has a substantially rectangular sectional shape, and is positioned on the lower left side of the high-velocity path 24b of the first upstream exhaust path 24.

The exhaust variable valve 3 is configured to change the flow area of the exhaust gas in each high-velocity path 24b, 25b, 26b of the upstream exhaust paths 24, 25, 26. The exhaust variable valve 3 includes a valve body 31 having the total of three butterfly valves 30 each arranged in the high-velocity paths 24b, 25b, 26b, a drive shaft 32 coupled to the valve body 31, and a negative pressure type actuator 4 configured to rotate the drive shaft 32. The exhaust variable valve 3 rotatably drives each butterfly valve 30 via the drive shaft 32 by the negative pressure type actuator 4, thereby simultaneously opening/closing each high-velocity path 24b, 25b, 26b.

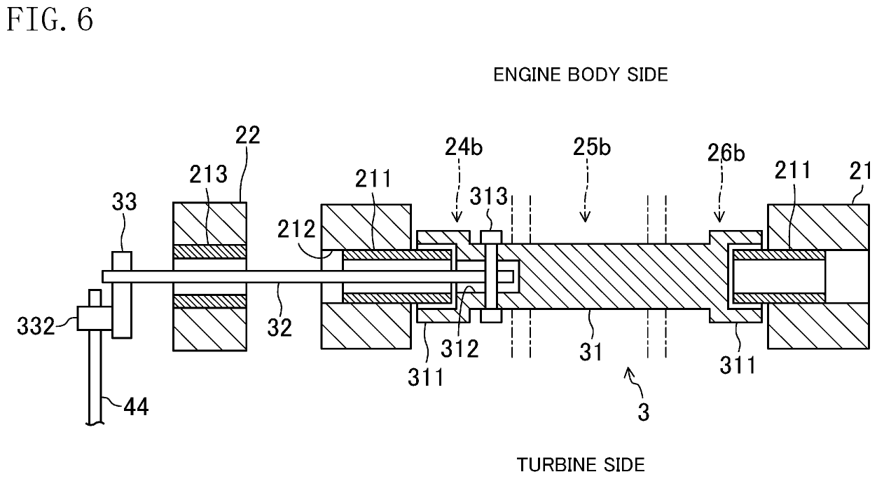

A configuration of the exhaust variable valve 3 will be specifically described herein. As illustrated in FIGS. 3 to 6, the valve body 31 is configured to couple three butterfly valves 30 arranged in the right-to-left direction. Center portions of cross sections of the high-velocity paths 24b, 25b, 26b arranged in the right-to-left direction communicate with each other in the right-to-left direction. As illustrated in FIGS. 3 and 6, the valve body 31 is arranged to extend in the right-to-left direction and cross the center portions of the cross sections of the high-velocity paths 24b, 25b, 26b communicating with each other. A support portion 311 is, at each of right and left end portions of the valve body 31, provided integrally with the valve body 31. Each support portion 311 has a support hole opening at an end surface. Valve support bushes 211 attached to the device body 21 are each inserted into two support portions 311 so that the valve body 31 can be configured to rotate about an axis X1. The valve body 31 is exposed to high-temperature exhaust gas, and for this reason, is made of a material exhibiting heat resistance.

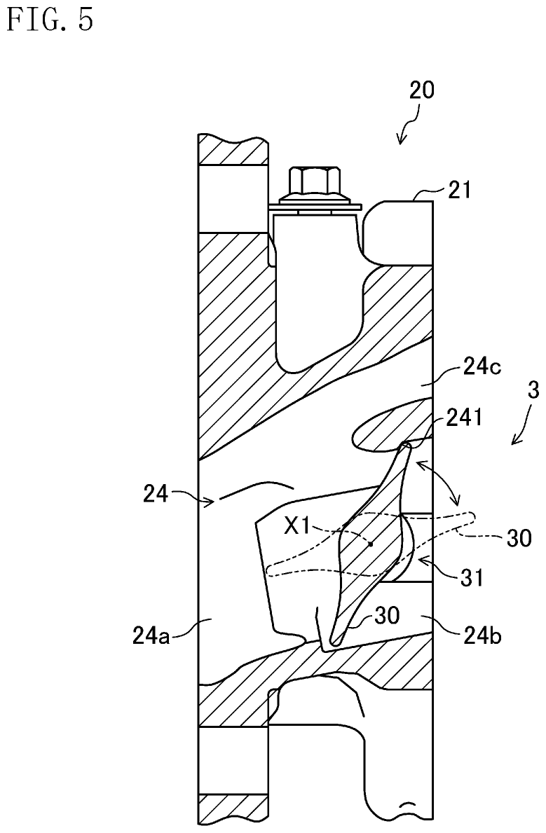

As illustrated in FIGS. 3 and 5, each butterfly valve 30 is formed in a rectangular plate shape corresponding to the sectional shape of the high-velocity path 24b, 25b, 26b. A seating surface 241 on which the butterfly valve 30 is to be seated is formed at an inner peripheral surface of each high-velocity path 24b, 25b, 26b. Each butterfly valve 30 is, by rotation of the valve body 31 in a clockwise direction in FIG. 5, switched from a state in which the high-velocity path 24b, 25b, 26b is closed by seating of the butterfly valve 30 on the seating surface 241 as indicated by a solid line in FIG. 5 to a state in which the high-velocity path 24b, 25b, 26b is opened as indicated by a chain double-dashed line.

The drive shaft 32 is coupled to the left end portion of the valve body 31. A recessed hole 312 is formed at the left end portion of the valve body 31. The recessed hole 312 opens at a left end surface of the valve body 31, and is recessed along the axis of the valve body 31. The depth of the recessed hole 312 is relatively small.

A base end portion (i.e., a right end portion in FIG. 6) of the drive shaft 32 is inserted into the recessed hole 312. The base end portion of the drive shaft 32 inserted into the recessed hole 312 is fixed to the valve body 31 in such a manner that a fastening pin 313 perpendicular to the drive shaft 32 penetrates such a base end portion. The fastening pin 313 also penetrates the valve body 31. Both end portions of the fastening pin 313 are welded to the valve body 31 at an outer peripheral surface of the valve body 31.

The drive shaft 32 extends outward of the left side of the upstream exhaust paths 24, 25, 26 through a through-hole 212 formed in the device body 21, the valve support bush 211 being inserted into the through-hole 212. A tip end portion of the drive shaft 32 is, by a shaft support bush 213, held to rotate about the axis X1. The shaft support bush 213 is attached to an auxiliary bearing portion 22 provided integrally with the device body 21. As also illustrated in FIG. 3, the auxiliary bearing portion 22 is separated from the upstream exhaust paths 24, 25, 26 by a predetermined distance.

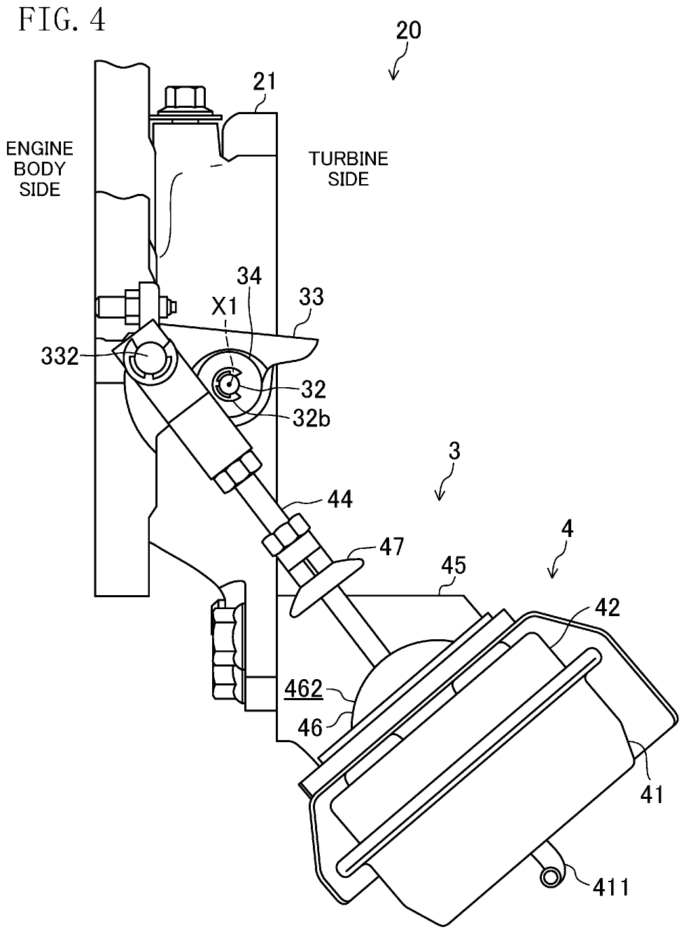

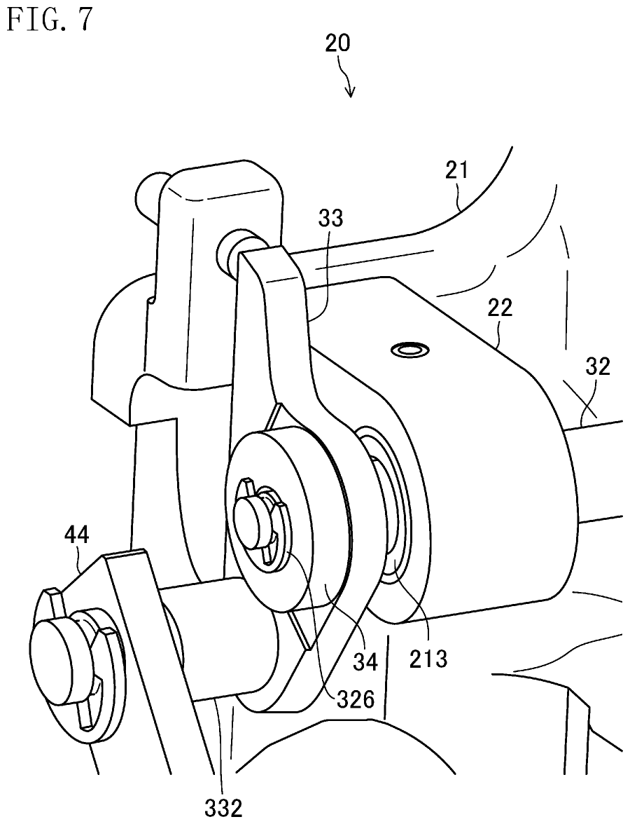

As illustrated in FIGS. 4 and 7, a lever member 33 is attached to the tip end portion of the drive shaft 32, specifically the tip end portion of the drive shaft 32 protruding leftward of the shaft support bush 213.

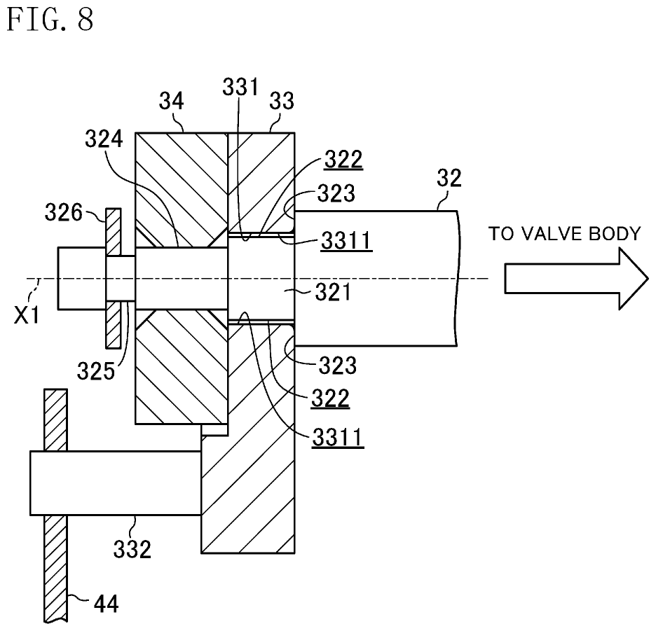

The lever member 33 is attached to a lever attachment portion 321 provided at the tip end portion of the drive shaft 32. As illustrated in FIGS. 8 to 10, the lever attachment portion 321 is formed in such a manner that two portions of a peripheral surface of the drive shaft 32 are processed into a flat shape. Two flat surfaces 322 of the lever attachment portion 321 are provided on both sides to sandwich the axis of the drive shaft 32, and are parallel to each other. The cross section of the lever attachment portion 321 is in a non-circular shape.

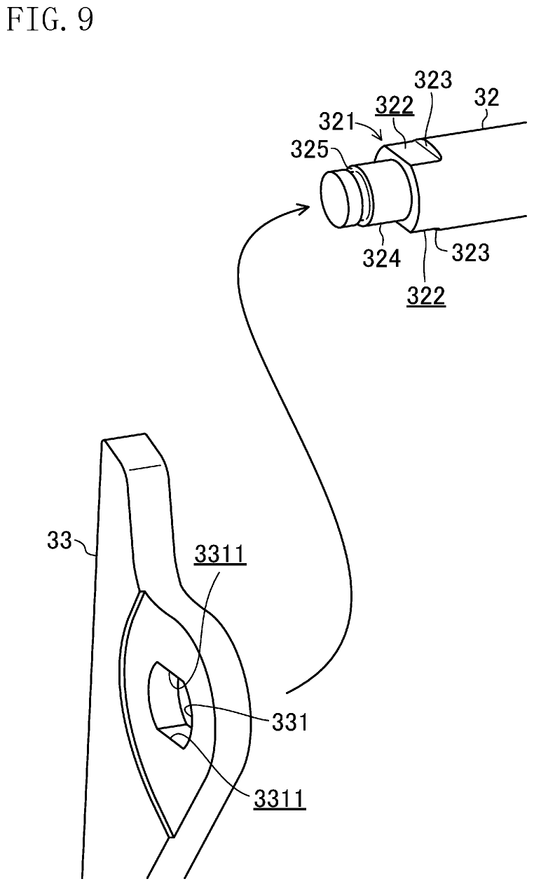

The lever member 33 has a through-hole 331 corresponding to the cross sectional shape of the lever attachment portion 321. As illustrated in FIGS. 8 and 9, the through-hole 331 has, at an inner peripheral surface thereof, two parallel flat surfaces 3311. The lever member 33 is fitted onto the lever attachment portion 321. The cross sectional shape of the lever attachment portion 321 is the non-circular shape, and the through-hole 331 of the lever member 33 corresponds to the cross sectional shape of the lever attachment portion 321. Thus, position determination in a rotation direction of the drive shaft 32 when the lever member 33 is assembled with the drive shaft 32 is facilitated.

At a portion of the lever attachment portion 321 of the drive shaft 32 adjacent to the butterfly valve 30, a second contact portion 323 configured to contact a side surface of the lever member 33 is provided integrally with the drive shaft 32. The second contact portion 323 is formed at the drive shaft 32 in such a manner that flattening as described above is performed for the drive shaft 32.

At a portion of the lever attachment portion 321 of the drive shaft 32 adjacent to the opposite side of the butterfly valve 30, a press-fitting portion 324 is formed. The cross section of the press-fitting portion 324 has a circular shape with a smaller diameter than that of the drive shaft 32. The press-fitting portion 324 has a smaller diameter than that of the lever attachment portion 321, and a step is provided between the press-fitting portion 324 and the lever attachment portion 321.

The press-fitting portion 324 is press-fitted in a first contact member 34 separated from the drive shaft 32. The first contact member 34 is a discoid member formed with a larger diameter than that of the drive shaft 32, and at the center thereof, has a through-hole with a circular cross section. The first contact member 34 is fixed to the drive shaft 32 in such a manner that the press-fitting portion 324 is press-fitted in the first contact member 34. The first contact member 34 press-fitted onto the press-fitting portion 324 contacts the side surface of the lever member 33. The lever member 33 is firmly fixed to the drive shaft 32 in such a manner that the lever member 33 is sandwiched between the first contact member 34 and the second contact portion 323 in an axial direction of the drive shaft 32.

As illustrated in FIG. 9, a groove 325 extending across the entire circumference is formed at a further tip end portion of the drive shaft 32. An E-ring 326 for avoiding detachment of the first contact member 34 is attached to the groove 325.

As illustrated in FIG. 8 etc., the lever member 33 has a pin 332 provided at a position apart from the center of the through-hole 331, i.e., the axis X1 of the drive shaft 32, by a predetermined distance. The pin 332 is parallel to the drive shaft 32. A tip end of an output shaft 44 of the negative pressure type actuator 4 is coupled to the pin 332.

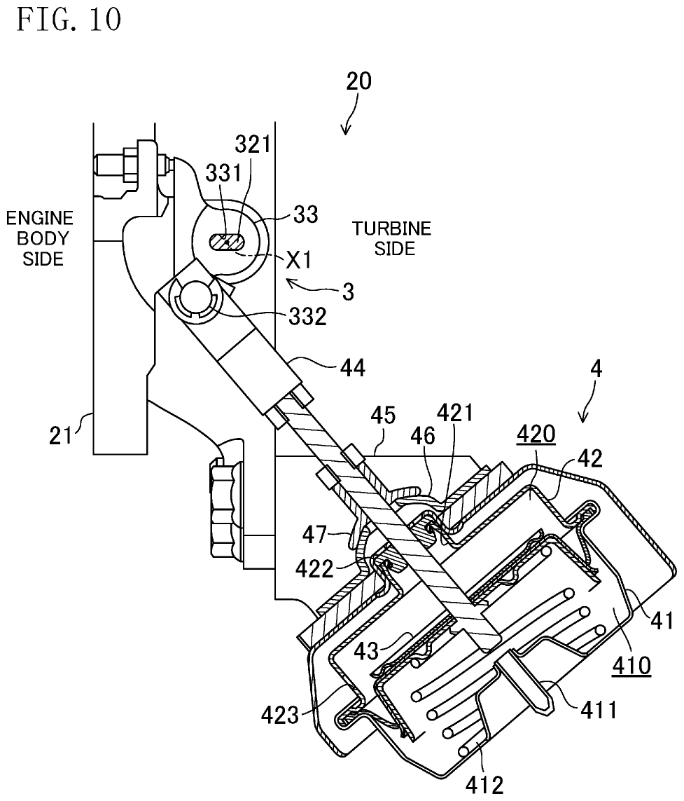

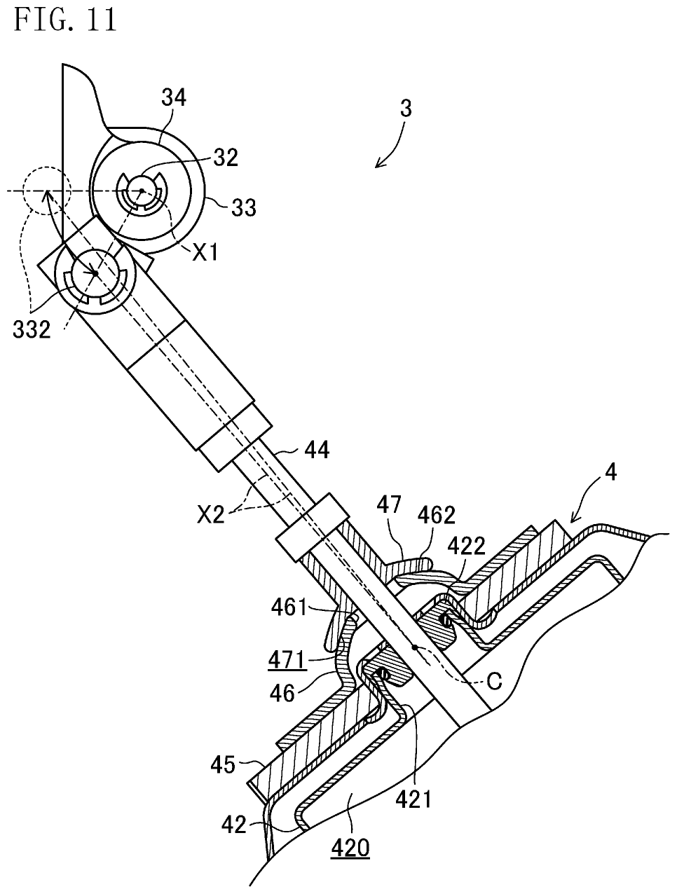

As illustrated in FIGS. 3 and 4, the negative pressure type actuator 4 is positioned close to a turbine 56 with respect to the device body 21, and is fixed to the device body 21 via a bracket 45 provided at the negative pressure type actuator 4. As illustrated in FIGS. 10 and 11, the negative pressure type actuator 4 includes a first casing 41, a second casing 42, a diaphragm 43, and the output shaft 44.

Each of the first casing 41 and the second casing 42 is in a cup shape, and the first casing 41 and the second casing 42 are joined together. With this configuration, a space is formed inside the negative pressure type actuator 4.

The diaphragm 43 is interposed between the first casing 41 and the second casing 42. The diaphragm 43 divides the inner space of the negative pressure type actuator 4 into a negative pressure chamber 410 positioned close to the first casing 41 and a positive pressure chamber 420 positioned close to the second casing 42.

The output shaft 44 is connected to the diaphragm 43. The output shaft 44 extends toward the opposite side of the negative pressure chamber 410 through a through-hole 421 formed at the second casing 42. As described above, a tip end portion of the output shaft 44 is coupled to the pin 332 of the lever member 33. The output shaft 44 extends downward diagonally from the device body 21 toward the turbine 56. The output shaft 44 is configured to advance/retreat in association with displacement of the diaphragm 43. In association with advancing/retreating of the output shaft 44, the lever member 33 swings about the axis X1 of the drive shaft 32, and the drive shaft 32 rotates about the center of the axis X1, as illustrated in FIG. 11.

A bush 422 is attached to the inside of the through-hole 421 of the second casing 42. The bush 422 is fitted onto the output shaft 44. The bush 422 closely contacts the output shaft 44, thereby holding an airtight state in the positive pressure chamber 420. Note that when the output shaft 44 advances/retreats, the bush 422 allows sliding of the output shaft 44.

A negative pressure pipe 411 is connected to a bottom portion of the first casing 41. A intake air negative pressure is supplied/released to/from the negative pressure chamber 410 through the negative pressure pipe 411. A compression spring 412 is arranged in the negative pressure chamber 410. The compression spring 412 biases the diaphragm 43 in the direction of advancing the output shaft 44. Note that FIG. 10 illustrates a state in which the negative pressure is supplied to the negative pressure chamber 410. A communication hole 423 allowing communication between the inside and the outside of the second casing 42 is provided at the second casing 42. The inside of the positive pressure chamber 420 is held at an atmospheric pressure. When the negative pressure is supplied to the negative pressure chamber 410, the output shaft 44 moves in a retreating direction, i.e., toward a negative pressure chamber side, due to a difference in a pressure acting on the diaphragm 43 between the negative pressure chamber 410 and the positive pressure chamber 420. When the negative pressure is released from the negative pressure chamber 410, the output shaft 44 moves in an advancing direction, i.e., toward the opposite side of the negative pressure chamber side, due to biasing force of the compression spring 412.

A stopper 46 is attached to the bracket 45 of the negative pressure type actuator 4. Note that in the present embodiment, the bracket 45 is attached on the track of advancing/retreating of the output shaft 44. The stopper 46 may be attached to the bracket 45 as long as the stopper 46 is attached on the track of advancing/retreating of the output shaft 44. For example, in a case where the bracket 45 is attached to other portions than a portion on the track, the stopper 46 may be directly attached to a body of the negative pressure type actuator 4.

A stopper engagement portion 47 to be engaged with the stopper 46 is fixed to the output shaft 44. The stopper 46 and the stopper engagement portion 47 engage with each other when the output shaft 44 moves in the retreating direction, thereby preventing the output shaft 44 from further moving in the retreating direction.

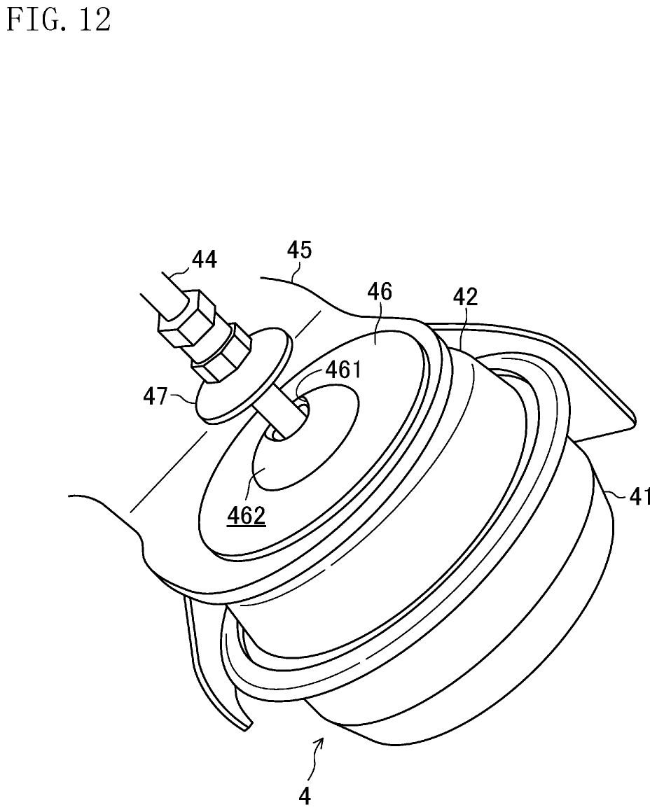

As illustrated in FIGS. 11 and 12, the stopper 46 is a hat-shaped member, and a passing hole 461 through which the output shaft 44 passes is formed at a center position of the stopper 46. The passing hole 461 has a sufficiently-larger diameter than the diameter of the output shaft 44. As will be described later, the output shaft 44 is inclined upon advancing/retreating. The diameter of the passing hole 461 is set as described above, and therefore, contact of the output shaft 44 with the passing hole 461 is avoided even when the output shaft 44 is inclined.

Moreover, the stopper 46 has, at the center position including the passing hole 461, a first contact surface 462 expanding in a raised shape. As illustrated in FIG. 11, the first contact surface 462 corresponds to a spherical surface about a center position C of the bush 422 holding the output shaft 44.

The stopper engagement portion 47 is fixed to an intermediate position of the output shaft 44. The stopper engagement portion 47 has a second contact surface 471 configured to contact the first contact surface 462 of the stopper 46. The second contact surface 471 is in a recessed spherical surface shape. As illustrated in FIG. 11, the second contact surface 471 corresponds to a spherical surface about the center position C of the bush 422.

In the exhaust valve device 20 with this configuration, when the exhaust variable valve 3 is closed, the intake air negative pressure is supplied to the negative pressure chamber 410 of the negative pressure type actuator 4 (i.e., the negative pressure type actuator is turned ON). This brings a state in which the output shaft 44 is pulled in the retreating direction. Thus, the lever member 33 is positioned in a state illustrated in FIG. 10, and each butterfly valve 30 closes the high-velocity path 24b, 25b, 26b as indicated by the solid line in FIG. 5.

On the other hand, when the exhaust variable valve 3 is opened, the intake air negative pressure is released from the negative pressure chamber 410 of the negative pressure type actuator 4 (i.e., the negative pressure type actuator is turned OFF). This brings a state in which the output shaft 44 is pushed out in the advancing direction due to the biasing force of the compression spring 412. Thus, the lever member 33 rotates clockwise, and the lever member 33 is positioned in a state illustrated in FIG. 4. Each butterfly valve 30 opens the high-velocity path 24b, 25b, 26b as indicated by the chain double-dashed line in FIG. 5. The exhaust variable valve 3 is configured as being normally opened.

The stopper engagement portion 47 attached to the middle of the output shaft 44 and the stopper 46 attached to the bracket 45 form a configuration for restricting the amount of movement of the output shaft 44 when the negative pressure is supplied to the negative pressure type actuator 4. Thus, in a state in which the stopper engagement portion 47 and the stopper 46 engage with each other, no pull-in force of the negative pressure type actuator 4 acts on the drive shaft 32. For such a state, a configuration may be employed, in which when the negative pressure is, for example, supplied to the negative pressure type actuator 4, the stopper attached to a predetermined position contacts the lever member 33 to restrict further swinging of the lever member 33. However, in this configuration, the pull-in force of the negative pressure type actuator 4 acts on the drive shaft 32 with the lever member 33 contacting the stopper (i.e., with the butterfly valves 30 being closed).

As described above, the exhaust variable valve 3 is configured such that the drive shaft 32 is coupled to the left end portion of the valve body 31. It is not configured such that the drive shaft 32 penetrates the valve body 31 in the right-to-left direction and is supported at the right of the valve body 31 by the device body 21, but the coupling-side end portion (i.e., the right end portion in FIG. 6) of the drive shaft 32 is welded to a middle position of the valve body 31 in the right-to-left direction. Thus, when a configuration in which the pull-in force of the negative pressure type actuator 4 acts on the end portion of the drive shaft 32 with the butterfly valves 30 being closed is employed, the left end portion of the drive shaft 32 is pulled downward in the plane of paper of FIG. 6, i.e., toward the turbine 56. Accordingly, the right end portion of the drive shaft 32, which is supported by the shaft support bush 213, in the recessed hole 312 pushes the valve body 31 upward in the plane of paper, i.e., toward the engine body 1. Meanwhile, the valve body 31 closing the high-velocity paths 24b, 25b, 26b is periodically pushed in a direction from the engine body 1 toward the turbine 56 due to exhaust pulsation. As a result, there is a probability that the valve body 31 vibrates.

On the other hand, in the above-described configuration, when the butterfly valves 30 are closed, the stopper engagement portion 47 attached to the middle of the output shaft 44 engages with the stopper 46. With this configuration, in a state in which the butterfly valves 30 are closed, no pull-in force of the negative pressure type actuator 4 acts on the drive shaft 32. Thus, in the above-described configuration, vibration of the valve body 31 due to exhaust pulsation can be prevented.

As illustrated in FIGS. 1 and 2, the turbosupercharger 50 is, with bolts, fixed to the device body 21 of the exhaust valve device 20. The turbosupercharger 50 includes the exhaust introduction path portion 51 fixed to an attachment surface 21a (see FIG. 3) of the device body 21, a turbine housing 52 continuous to the exhaust introduction path portion 51, the turbine 56 arranged in the turbine housing 52, and a compressor coupled to the turbine 56 via a coupling shaft 57 and arranged in a not-shown intake air path.

The exhaust introduction path portion 51 has separate high-velocity path 51b and low-velocity path 51c communicating with each of the high-velocity paths 24b, 25b, 26b and the low-velocity paths 24c, 25c, 26c of the exhaust valve device 20. Although not specifically shown in the figure, the high-velocity path 51b of the exhaust introduction path portion 51 joins three separate high-velocity paths 24b, 25b, 26b in the exhaust valve device 20. Similarly, the low-velocity path 51c of the exhaust introduction path portion 51 joins three separate low-velocity paths 24c, 25c, 26c in the exhaust valve device 20.

The exhaust introduction path portion 51 includes, at a downstream end portion thereof, the junction portion 54 at which the high-velocity path 51b and the low-velocity path 51c join together. The exhaust gas from the high-velocity path 51b of the exhaust introduction path portion and the exhaust gas from the low-velocity path 51c of the exhaust introduction path portion join together at the junction portion 54, and then, are sent to the turbine 56.

As described above, this engine does not include the separate component as the exhaust manifold, and the separate exhaust paths 14, 15, 16 of the engine body 1 (the cylinder head 10), the upstream exhaust paths 24, 25, 26 of the exhaust valve device 20, and the exhaust introduction path portion 51 and the junction portion 54 of the turbosupercharger 50 are combined to form the exhaust manifold.

Moreover, an EGR upstream path 58 communicating with the EGR intermediate path 28 of the exhaust valve device 20 is formed at a portion at the left of the exhaust introduction path portion 51 of the turbine housing 52. Part of the exhaust gas flowing into the turbosupercharger 50 is, as EGR gas, introduced into the intake air path through the EGR upstream path 58, the EGR intermediate path 28, and the EGR downstream path 18. That is, in this engine, the EGR downstream path 18, the EGR intermediate path 28, and the EGR upstream path 58 form an EGR path.

In the engine configured as described above, the exhaust gas generated in the engine body 1 is introduced into the turbosupercharger 50 from the separate exhaust paths 14, 15, 16 through the upstream exhaust paths 24, 25, 26 of the exhaust valve device 20. At this point, the flow area of the exhaust gas flowing in each high-velocity path 24b, 25b, 26b of the exhaust valve device 20 is changed according to the vehicle operation state.

Specifically, in the low rotation range in which the rotation speed of the engine body 1 is equal to or lower than a predetermined rotation speed (e.g., 1600 rpm), the exhaust valve device 20 is controlled such that the high-velocity paths 24b, 25b, 26b are closed. That is, the intake air negative pressure is supplied to the negative pressure chamber 410 of the negative pressure type actuator 4, and in this manner, the state in which the output shaft 44 is pulled in the retreating direction is brought. Thus, the lever member 33 is positioned in the state illustrated in FIG. 10, and each butterfly valve 30 closes the high-velocity path 24b, 25b, 26b as indicated by the solid line in FIG. 5. In this manner, a small amount of exhaust gas is concentrated on the low-velocity paths 24c, 25c, 26c, and therefore, the flow velocity of the exhaust gas is increased. This increases drive force of the turbine 56 of the turbosupercharger 50, thereby increasing the boost pressure.

On the other hand, in the high rotation range in which the rotation speed of the engine body 1 exceeds the predetermined rotation speed, there is a probability that scavenging performance is lowered due to path resistance when passage of the exhaust gas is allowed by means of only the low-velocity paths 24c, 25c, 26c. For this reason, the exhaust valve device 20 is controlled such that the high-velocity paths 24b, 25b, 26b are opened. That is, the intake air negative pressure is released from the negative pressure chamber 410 of the negative pressure type actuator 4, and in this manner, the state in which the output shaft 44 is pushed out in the advancing direction due to the biasing force of the compression spring 412 is brought. Thus, the lever member 33 is positioned in the state illustrated in FIG. 4, and each butterfly valve 30 opens the high-velocity path 24b, 25b, 26b as indicated by the chain double-dashed line in FIG. 5. The exhaust gas is introduced into the turbosupercharger 50 through both of the high-velocity paths 24b, 25b, 26b and the low-velocity paths 24c, 25c, 26c. Thus, lowering of the scavenging performance due to the exhaust path resistance is reduced while the turbosupercharger 50 is driven to increase the boost pressure.

In the exhaust device configured as described above, the valve body 31 receives a high exhaust gas pressure when each high-velocity path 24b, 25b, 26b is closed.

As illustrated in FIG. 9 etc., the lever attachment portion 321 of the drive shaft 32 is processed to have two flat surfaces 322 for position determination of the lever member 33. By such processing, dimension accuracy for press-fitting the lever member 33 onto the lever attachment portion 321 cannot be ensured, and a clearance is formed between the through-hole 331 of the lever member 33 and the lever attachment portion 321. In a state in which the clearance is present, when the valve body 31 receives the gas pressure, the lever member 33 and the drive shaft 32 rattle. Since the exhaust variable valve 3 is closed in the low rotation range of the engine body 1 as described above, there is a probability that noise is caused in the vicinity of the attachment portion of the lever member 33 due to exhaust pulsation in the low rotation range of the engine body 1.

In particular, the valve body 31 is exposed to the high-temperature exhaust gas, and for this reason, is made of the material exhibiting heat resistance. Considering a difficulty in processing of such a material, the drive shaft 32 coupled to the valve body 31 is, as illustrated in FIG. 6, inserted into the recessed hole 312 formed at the left end portion of the solid valve body 31, and is fixed to the valve body 31 with the fastening pin 313. In this configuration, when the valve body 31 receives the gas pressure in each high-velocity path 24b, 25b, 26b, the left end portion of the drive shaft 32 separated from the valve body 31 is easily movable. That is, this configuration is a configuration in which the lever member 33 and the drive shaft 32 easily rattle.

However, in the above-described configuration, the lever member 33 is, in the axial direction of the drive shaft 32, sandwiched between the first contact member 34 press-fitted onto the press-fitting portion 324 of the drive shaft 32 and the second contact portion 323 provided integrally with the drive shaft 32. With this configuration, the lever member 33 is firmly fixed to the drive shaft 32. This prevents rattling of the lever member 33 and the drive shaft 32 when the valve body 31 receives the gas pressure. Occurrence of the noise at the attachment portion of the lever member 33 is prevented.

The first contact member 34 described herein is configured as the component separated from the drive shaft 32, and the second contact portion 323 is provided integrally with the second contact portion 323. Thus, the drive shaft 32 and the lever member 33 can be easily assembled together.

The first contact member 34 is fitted onto the press-fitting portion 324 of the drive shaft 32. With this configuration, even when vibration is caused due to the gas pressure received by the valve body 31 or rotation of the drive shaft 32 in association with swinging of the lever member 33, the first contact member 34 is less loosened, and the state of stably fixing the first contact member 34 to the drive shaft 32 can be maintained for a long period of time. As described above, the predetermined rotation speed for switching opening/closing of the butterfly valve 30 is set to, e.g., 1600 rpm, and therefore, the frequency of opening/closing of the butterfly valve 30 is high. Thus, stable fixing of the first contact member 34 to the drive shaft 32 for the long period of time enhances reliability of the exhaust device 100.

Further, the valve body 31 arranged in the high-velocity paths 24b, 25b, 26b reaches a high temperature, and the drive shaft 32 coupled to the valve body 31 also reaches a high temperature. This leads to thermal expansion. Thus, the lever attachment portion 321 of the drive shaft 32 is separated from the high-velocity paths 24b, 25b, 26b by a predetermined distance, and therefore, thermal expansion at the attachment portion between the drive shaft 32 and the lever member 33 is reduced. As a result, an adverse effect due to thermal expansion can be avoided at the attachment portion between the drive shaft 32 and the lever member 33. In the present embodiment, the drive shaft 32 extends to the vicinity of the tip end of the output shaft 44, and the lever attachment portion 321 is provided at one end portion of the drive shaft 32. Thus, the lever attachment portion 321 is sufficiently separated from the high-velocity paths 24b, 25b, 26b.

The first contact member 34 described herein is made of a material having a smaller linear coefficient of expansion than that of the drive shaft 32. With this configuration, the amount of deformation due to heat of the drive shaft 32 is, at the attachment portion of the lever member 33, greater than the amount of deformation due to heat of the first contact member 34. Thus, even when the drive shaft 32 is thermally expanded, the first contact member 34 can be maintained at a state in which the first contact member 34 is press-fitted onto the drive shaft 32.

Note that in the above-described configuration, the lever attachment portion 321 is configured such that two portions of the peripheral surface thereof are in the flat surface shape, but may be configured such that a single portion of the peripheral surface thereof is in a flat surface shape. Moreover, as long as the cross section of the lever attachment portion 321 is at least formed in the non-circular shape, position determination of the lever member 33 is facilitated. Note that the through-hole of the lever member 33 is formed in a shape corresponding to the cross sectional shape of the lever attachment portion 321.

In the above-described configuration, the first contact member 34 is fixed to the drive shaft 32 by press-fitting onto the drive shaft 32. However, the first contact member 34 may be fixed to the drive shaft 32 in other methods than press-fitting. For example, the first contact member 34 may be fixed to the drive shaft 32 by a method such as screwing.

Note that the first contact member 34 as the member separated from the drive shaft 32 is not necessarily prepared. The lever member 33 may be fixed to the drive shaft 32 in such a manner that a flange-shaped first contact portion is provided by crushing of the end portion of the drive shaft 32 after the lever member 33 is fitted onto the lever attachment portion 321 and the lever member 33 is sandwiched between the first contact portion and the second contact portion 323. In this configuration, rattling of the lever member 33 and the drive shaft 32 can be also prevented.

Moreover, this technique is not limited to a valve mechanism including the butterfly valves 30, and is broadly applicable to a valve mechanism including a valve configured to rotate by a drive shaft.

In the exhaust device 100 configured as described above, the output shaft 44 of the negative pressure type actuator 4 not only advances/retreats in an axial direction thereof, but also advances/retreats while being inclined. Specifically, as illustrated in FIG. 11, the lever member 33 swings about the axis X1 of the drive shaft 32, and therefore, the pin 332 of the lever member 33 displaces along an arc about the axis X1 of the drive shaft 32 as indicated by a solid line and a dashed line in FIG. 11. The tip end of the output shaft 44 of the negative pressure type actuator 4 is connected to the pin 332, and therefore, the axis X2 of the output shaft 44 indicated by chain lines in FIG. 11 is, in association with advancing/retreating of the output shaft 44, inclined about a pivot point, i.e., the center position C of the bush 422. Note that “inclination of the output shaft 44” means that the angle of the output shaft 44 arranged between the lever member 33 and the negative pressure type actuator 4 changes.

When the stopper 46 and the stopper engagement portion 47 contact with each other, if the stopper 46 and the stopper engagement portion 47 are not in surface contact but in point contact with each other, an impact load is locally input to the stopper 46. Moreover, when it is configured such that the output shaft 44 is moved at high speed for enhancing responsiveness when the exhaust variable valve 3 is closed by a supply of the intake air negative pressure to the negative pressure chamber 410 of the negative pressure type actuator 4, the impact load locally input to the stopper 46 further increases. As described above, the frequency of opening/closing the exhaust variable valve 3 is relatively high. Thus, there is a probability that reliability and durability of the configurations of the stopper 46 and the stopper engagement portion 47 for restricting the amount of movement of the output shaft of the negative pressure type actuator 4 are lowered.

In the above-described configuration, the first contact surface 462 of the stopper 46 is formed in the spherical surface shape about the center position C of the bush 422, and the second contact surface 471 of the stopper engagement portion 47 is formed in the recessed spherical surface shape about the center position C of the bush 422. With this configuration, the stopper engagement portion 47 comes into surface contact with the stopper 46 even when the output shaft 44 is inclined. As a result, local input of the impact load on the stopper is avoided. Even when contact between the stopper 46 and the stopper engagement portion 47 is repeated for enhancing operation responsiveness of the butterfly valve 30, the impact load can be received by the surface, and therefore, high reliability and durability can be ensured.

When the length of the drive shaft 32 in the axial direction thereof is increased due to thermal expansion, the output shaft 44 of the negative pressure type actuator 4 is inclined with respect to the axial direction of the drive shaft 32. The stopper 46 is configured such that the first contact surface 462 is in the spherical surface shape, and the stopper engagement portion 47 is configured such that the second contact surface 471 is in the recessed spherical surface shape. Thus, even when the output shaft 44 is inclined in the direction of the drive shaft 32, the stopper 46 and the stopper engagement portion 47 are in surface contact with each other. Thus, local input of the impact load to the stopper 46 is also avoided upon thermal expansion of the drive shaft 32.

Note that in the above-described configuration, the first contact surface 462 of the stopper 46 is in the spherical surface shape, and the second contact surface 471 of the stopper engagement portion 47 is in the recessed spherical surface shape. However, the shapes of the first contact surface 462 and the second contact surface 471 are not limited to the spherical shape. As illustrated in FIG. 11, the output shaft 44 is inclined in the section including the axis X2. Thus, the first contact surface 462 of the stopper 46 may be an arc-shaped surface at least in the above-described section. Similarly, the second contact surface 471 of the stopper engagement portion 47 may be an arc-shaped surface with the same curvature as that of the first contact surface 462 at least in the above-described section.

The first contact surface 462 may be in a recessed spherical shape, and the second contact surface 471 may be in a spherical shape to contact the first contact surface 462. Similarly, in a configuration in which the first contact surface 462 and the second contact surface 471 are arc-shaped surfaces at least in the above-described section, a raised-recessed relationship between the first contact surface 462 and the second contact surface 471 may be interchanged.

Note that the engine of the above-described embodiment is an example of a preferable embodiment of a turbosupercharger-equipped multiple-cylinder engine. Specific configurations of the engine and the exhaust valve device 20 incorporated into the engine can be changed as necessary without departing from the gist of the present invention.

Moreover, in the above-described embodiment, the example where the exhaust device is applied to the in-line four-cylinder four-cycle engine has been described. However, the exhaust device disclosed herein is, needless to say, also applicable to other engines than that of the above-described embodiment.

### DESCRIPTION OF REFERENCE CHARACTERS

(1) Engine Body
(100) Exhaust device
(24b), (25b), (26b) High-Velocity Path (First Path)
(24c), (25c), (26c) Low-Velocity Path (Second Path)
(30) Butterfly Valve (Valve)
(32) Drive Shaft
(321) Lever Attachment Portion
(322) Flat Surface
(323) Second Contact Portion
(33) Lever Member
(331) Through-Hole
(3311) Flat Surface
(34) First Contact Member (First Contact Portion)
(4) Negative Pressure Type Actuator
(41) First Casing
(410) Negative Pressure Chamber
(42) Second Casing
(43) Diaphragm
(44) Output Shaft
(46) Stopper
(462) First Contact Surface
(47) Stopper Engagement Portion
(471) Second Contact Surface

1. A valve mechanism comprising:
a valve arranged in a path in which gas flows and configured to open/close the path;
a drive shaft coupled to the valve and configured to rotate the valve; and
a lever member attached to a lever attachment portion provided at the drive shaft and configured to swing about the drive shaft to rotate the drive shaft,
wherein the lever attachment portion of the drive shaft has a non-circular cross-sectional shape, and
the lever member
has a through-hole in a shape corresponding to a non-circular cross section of the lever attachment portion,
is fitted onto the lever attachment portion, and
is fixed to the drive shaft in such a manner that a first contact portion and a second contact portion provided on the drive shaft contact a side surface of the lever member to sandwich the lever member in an axial direction of the drive shaft.

2. The valve mechanism according to claim 1, wherein
the lever attachment portion has a flat surface at part of a peripheral surface thereof, and
the through-hole of the lever member has, at part of an inner peripheral surface thereof, a flat surface configured to contact the flat surface of the lever attachment portion.

3. The valve mechanism according to claim 1, wherein
the first contact portion includes a first contact member fitted onto the drive shaft and separated from the drive shaft, and
the second contact portion is provided integrally with the drive shaft at a portion adjacent to the lever attachment portion of the drive shaft in the axial direction.

4. The valve mechanism according to claim 3, wherein
the first contact member is press-fitted onto the drive shaft.

5. An engine exhaust device including the valve mechanism according to claim 1, comprising:
an exhaust path including a first path and a second path provided in parallel to each other,
wherein the valve is arranged in the first path, and is configured to open/close the first path,
the drive shaft extends outward of the exhaust path, and
the lever attachment portion is provided at an end portion of the drive shaft, the end portion being separated from the exhaust path by a predetermined distance.

6. The engine exhaust device according to claim 5, wherein
the first contact portion includes the first contact member fitted onto the drive shaft and separated from the drive shaft, and
the first contact member is made of a material having a smaller linear coefficient of expansion than that of the drive shaft.
